(19) United States
(12) Patent Application Publication
(10) Pub. No.: US 2020/0070785 A1
(43) Pub. Date: Mar. 5, 2020

(54) AIR TRANSFER SYSTEM FOR USE WITH TIRES

(71) Applicant: Troy MULLINS, White Marsh, MD (US)

(72) Inventor: Troy MULLINS, White Marsh, MD (US)

(21) Appl. No.: 16/117,460

(22) Filed: Aug. 30, 2018

(51) Int. Cl. B60S 5/04

(52) U.S. Cl. CPC B60S 5/04; B60S 5/043

(57) ABSTRACT

An apparatus for transferring air from one vessel to another vessel that includes a hose of predetermined diameter and length having a first end and a second end; a first device attached to the first end of the hose for removing air or other gas from a first vessel; and a second device attached to the second end of the hose for dispensing the air or other gas from the first vessel into a second vessel or out of the second end of the hose.

### BACKGROUND OF THE INVENTION

The described invention relates in general to systems, devices, and methods for inflating and deflating tires and other inflated or inflatable items, and more specifically to a system, apparatus and method for transferring air or other gas from a first vessel such as a tire that contains a volume of air or other gas to a second vessel such as a tire that is filled with a second volume of air or other gas that is less than the volume contained by the first vessel.

Flat or deflated tires are a common problem with regard to all types of vehicles and other items that utilize tires having innertubes that are filled with air or other gases. Refilling a deflated tire typically requires a hand or foot pump or an air compressor that further requires a source of electrical power. In certain circumstances, a foot or hand pump may not be available and even if an air compressor is available, a source of electrical power may not be available. Accordingly, there is an ongoing need for a relatively passive system for transferring air or other gas from an inflated tire (or other vessel) to a tire (or other vessel) that is deflated for the purpose of inflating the deflated vessel long enough for it to fulfill its basic purpose. In the case of a deflated tire, filling the deflated tire with enough air to drive the vehicle on which the deflated tire is mounted to a location where the deflated tire may be repaired or replaced, is a highly desirable outcome.

### SUMMARY OF THE INVENTION

The following provides a summary of certain exemplary embodiments of the present invention. This summary is not an extensive overview and is not intended to identify key or critical aspects or elements of the present invention or to delineate its scope. However, it is to be understood that the use of indefinite articles in the language used to describe and claim the present invention is not intended in any way to limit the described system. Rather the use of “a” or “an” should be interpreted to mean “at least one” or “one or more”.

In accordance with one aspect of the present invention, an apparatus for transferring air from one vessel to another vessel is provided. This apparatus includes a hose of predetermined diameter and length having a first end and a second end; a first device attached to the first end of the hose for removing air or other gas from a first vessel; and a second device attached to the second end of the hose for dispensing the air or other gas from the first vessel into a second vessel or out of the second end of the hose.

In accordance with another aspect of the present invention, a system for transferring air from one vessel to another vessel is provided. This system include a first vessel containing air or other gas, wherein the air or other gas is at a predetermined pressure within the first vessel; a second vessel containing air or other gas, wherein the air or other gas is at a predetermined pressure within the second vessel; a hose of predetermined diameter and length having a first end and a second end; a first device attached to the first end of the hose for removing the air or other gas from the first vessel; and a second device attached to the second end of the hose for dispensing the air or other gas from the first vessel into the second vessel or out of the second end of the hose, wherein the air or other gas flows through the hose from the first device to the second device when the air pressure in the first vessel is greater than the air pressure in the second vessel.

In yet another aspect of this invention, a system for transferring air from one tire to another tire is provided. This system includes a first tire containing air or other gas, wherein the air or other gas is at a predetermined pressure within the first tire; a second tire containing air or other gas, wherein the air or other gas is at a predetermined pressure within the second tire; a hose of predetermined diameter and length having a first end and a second end; a first air chuck attached to the first end of the hose for removing the air or other gas from the first tire; and a second air chuck attached to the second end of the hose for dispensing the air or other gas from the first tire into the second tire, wherein the air or other gas flows through the hose from the first air chuck to the second air chuck when the air pressure in the first tire is greater than the air pressure in the second tire.

Additional features and aspects of the present invention will become apparent to those of ordinary skill in the art upon reading and understanding the following detailed description of the exemplary embodiments. As will be appreciated by the skilled artisan, further embodiments of the invention are possible without departing from the scope and spirit of the invention. Accordingly, the drawings and associated descriptions are to be regarded as illustrative and not restrictive in nature.

### BRIEF DESCRIPTION OF THE DRAWINGS

The accompanying drawings, which are incorporated into and form a part of the specification, schematically illustrate one or more exemplary embodiments of the invention and, together with the general description given above and detailed description given below, serve to explain the principles of the invention, and wherein:

FIG. 1 is a top view of an air transfer system and apparatus in accordance with a first exemplary embodiment of the present invention;

FIG. 2 is a top view of an air transfer system and apparatus in accordance with a second exemplary embodiment of the present invention; and

FIG. 3 is an illustration of the air transfer system and apparatus of FIG. 2 attached to a vehicle and in use.

### DETAILED DESCRIPTION OF THE INVENTION

Exemplary embodiments of the present invention are now described with reference to the Figures. Reference numerals are used throughout the detailed description to refer to the various elements and structures. Although the following detailed description contains many specifics for the purposes of illustration, a person of ordinary skill in the art will appreciate that many variations and alterations to the following details are within the scope of the invention. Accordingly, the following embodiments of the invention are set forth without any loss of generality to, and without imposing limitations upon, the claimed invention.

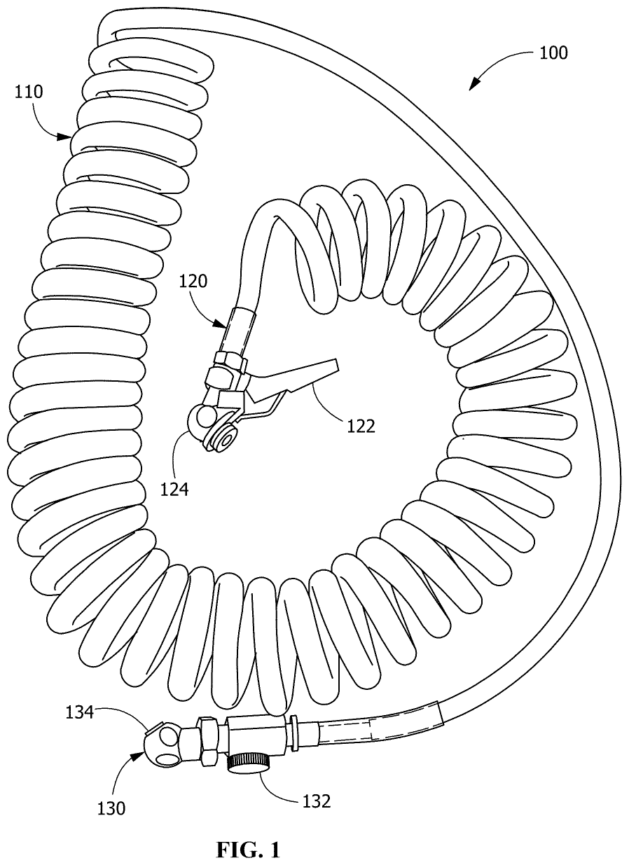

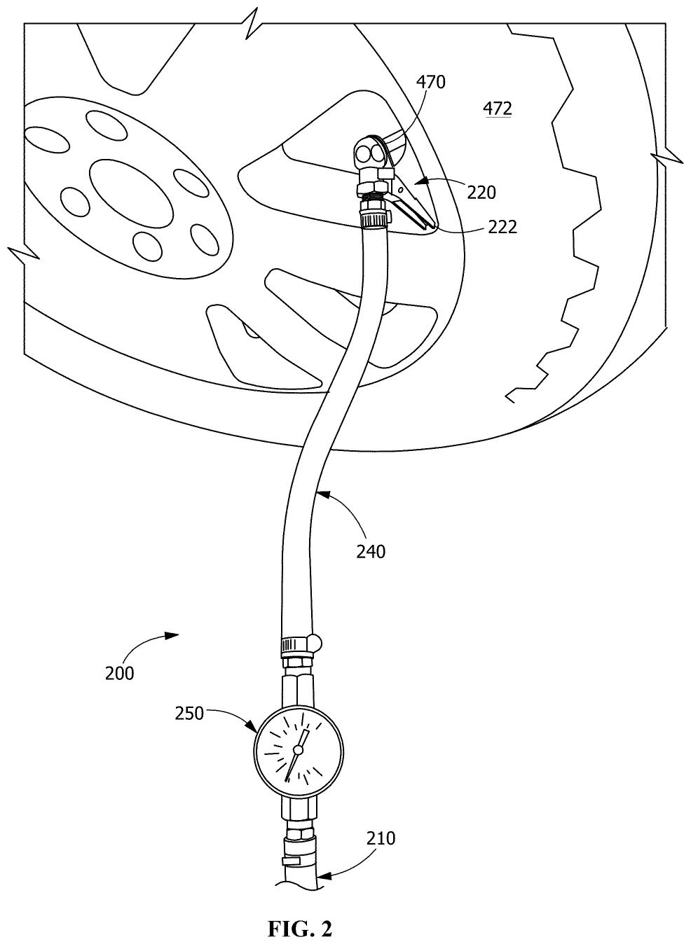

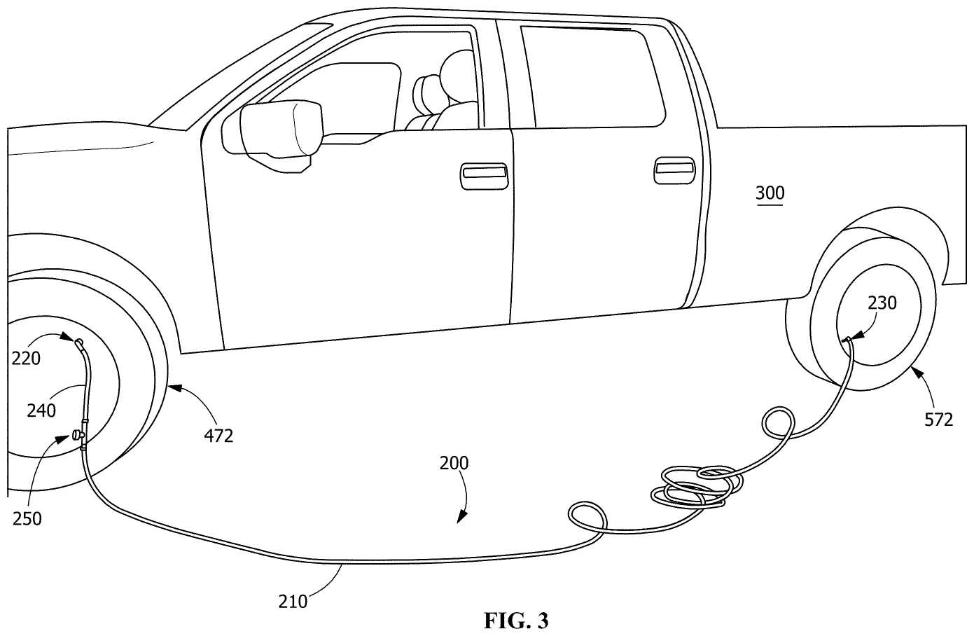

As previously stated, the described invention relates in general to systems, devices, and methods for inflating and deflating tires and other inflated or inflatable items, and more specifically to a system, apparatus, and method for transferring air or other gas from a first vessel such as a tire that contains a volume of air or other gas to a second vessel such as a tire that is filled with a second volume of air or other gas that is less than the volume contained by the first vessel. With reference now to the Figures, FIG. 1 is a top view of an air transfer system and apparatus in accordance with a first exemplary embodiment of the present invention; FIG. 2 is a top view of an air transfer system and apparatus in accordance with a second exemplary embodiment of the present invention; and FIG. 3 is an illustration of one version of the air transfer system and apparatus of FIG. 2 attached to a vehicle and in use.

As shown in FIG. 1, exemplary air transfer apparatus 100 includes hose 110; first air chuck 120, which is attached to one end of hose 110; and second air chuck 130, which is attached to the opposite end of hose 110. In this embodiment, first air chuck 120 includes locking clip 122 and head portion 124; and second air chuck 130 includes air flow dial 132 and head portion 134. Head portions 124 and 134 house valve pins that engage corresponding structures in the valve stems of tires or other inflatable items. In this embodiment, hose 110 is coiled and may be of variable length such as, for example, 12-15 feet, although any useful length may be used. The diameter of hose 110 is about one quarter inch to about three-eighths inch, although any useful diameter may be used.

As shown in FIG. 2, exemplary air transfer apparatus 200 includes hose 210 to which first air chuck 220 is attached. In this embodiment, first air chuck 220 includes locking clip 222 and head portion 224, which houses a valve pin. Connector hose 240 is attached to first air check 220 and optional pressure gauge 250 is positioned in-line between hose 210 and connector hose 240. In some embodiments, connector hose 240 is not present and pressure gauge 250 is connected directly to first air chuck 220. Although not shown in this image, any of the following items may be mounted on the opposite end of hose 210: a second air chuck, an inflation needle, an inflation valve, an air nozzle tip, or an air gun tip. In this embodiment, hose 210 is straight and may be of variable length such as, for example, 12-25 feet, although any useful length may be used. The diameter of hose 210 is about one quarter inch to about three-eighths inch, although any useful diameter may be used.

FIG. 3 is an illustration of the air transfer system and apparatus of FIG. 2 attached to vehicle 300 and in use. In FIG. 3, first air chuck 220 is attached to first tire valve 470 on first tire 472 and second air chuck 230 is attached to second tire valve 570 on second tire 572. In FIG. 3, first tire 472 contains a greater volume of air and has a higher air pressure than second tire 572. Accordingly, when air transfer apparatus 200 is attached to first tire valve 470 on first tire 472 and second air chuck 230 is attached to second tire valve 570 on second tire 572, air flows from first tire 472 to second tire 572 through hose 210 and inflates second tire 572. Optional pressure gauge 250 may be used to assure that the air pressure within first tire 472 does not drop below a safe operating level for first tire 472 and vehicle 300.

In other embodiments of this invention, a car or truck tire or other inflated vessel may be used as a source of pressurized air, and the air transfer system of this invention may be used to transfer air from the car or truck tire or other inflated vessel to an inflatable sporting item (e.g., basketball or football), an inflatable floating item (pool flotation device), an inflatable toy, or any other inflatable item by using the appropriate connectors as described herein. All of the components used for the air transfer system and apparatus of the present invention are plastic, reinforced plastic, metal, rubber, reinforced rubber, or other common materials and can be purchased online or from various other commercial sources. Various configurations of the disclosed system and apparatus are possible based on intended use, storage conditions, durability requirements, and other relevant design factors, including cost. In certain embodiments of this invention, the apparatus includes a first air chuck and a second air chuck connected to one another by the air hose, which may or may not be reinforced and which may be coiled or straight. The air hose may be of any useful length and diameter. In some embodiments, the second air chuck is replaced with an inflation needle, an inflation valve, an air nozzle tip, air gun tip, or any other type of useful tip or device. In some embodiments, the first air chuck includes a locking clip and is connected to a pressure gauge either directly or indirectly (using a secondary air hose) and, optionally, the second air chuck may also include a locking clip. As in other embodiments, the second air chuck may be replaced with an inflation needle, an inflation valve, an air nozzle tip, an air gun tip, or any other compatible device. The system and apparatus of the present invention may be modified and/or reconfigured for use in various environments and for various purposes, including use with cars, trucks, and other vehicles; use with inflatable sporting goods; and use with toys and other inflatable items. Various embodiments are configured for use in commercial/industrial environments, while other are configured for use in outdoor environments and/or home environments. The invention is scalable and adaptable for numerous applications.

While the present invention has been illustrated by the description of exemplary embodiments thereof, and while the embodiments have been described in certain detail, there is no intention to restrict or in any way limit the scope of the appended claims to such detail. Additional advantages and modifications will readily appear to those skilled in the art. Therefore, the invention in its broader aspects is not limited to any of the specific details, representative devices and methods, and/or illustrative examples shown and described. Accordingly, departures may be made from such details without departing from the spirit or scope of the general inventive concept.

What is claimed:

1. An apparatus for transferring air from one vessel to another vessel, comprising:
(a) a hose of predetermined diameter and length having a first end and a second end;
(b) a first device attached to the first end of the hose for removing air or other gas from a first vessel; and
(c) a second device attached to the second end of the hose for dispensing the air or other gas from the first vessel into a second vessel or out of the second end of the hose.

2. The apparatus of claim 1, further comprising at least one pressure gauge mounted on the hose at a predetermined location.

3. The apparatus of claim 1, wherein the hose is coiled or uncoiled, wherein the length of the hose is about twelve feet to about twenty-five feet, and wherein the diameter of the hose is about one quarter inch to about three-eighths inch.

4. The apparatus of claim 1, wherein the first device is an air chuck and wherein the second device is an air chuck.

5. The apparatus of claim 4, wherein the first air chuck includes a locking clip and wherein the second air chuck includes an air-flow adjustment knob.

6. The apparatus of claim 1, wherein the second device is an inflation needle, an inflation valve, an air nozzle tip, or an air gun tip.

7. The apparatus of claim 1, wherein the first vessel is a tire and wherein the second vessel is a tire.

8. The apparatus of claim 1, wherein the first vessel is a tire and wherein the second vessel is an inflatable sporting item, an inflatable floating item, or an inflatable toy.

9. A system for transferring air from one vessel to another vessel, comprising:
(a) a first vessel containing air or other gas, wherein the air or other gas is at a predetermined pressure within the first vessel;
(b) a second vessel containing air or other gas, wherein the air or other gas is at a predetermined pressure within the second vessel;
(c) a hose of predetermined diameter and length having a first end and a second end;
(d) a first device attached to the first end of the hose for removing the air or other gas from the first vessel; and
(e) a second device attached to the second end of the hose for dispensing the air or other gas from the first vessel into the second vessel or out of the second end of the hose,
(f) wherein the air or other gas flows through the hose from the first device to the second device when the air pressure in the first vessel is greater than the air pressure in the second vessel.

10. The system of claim 9, further comprising at least one pressure gauge mounted on the hose at a predetermined location.

11. The system of claim 9, wherein the hose is coiled or uncoiled, wherein the length of the hose is about twelve feet to about twenty-five feet, and wherein the diameter of the hose is about one quarter inch to about three-eighths inch.

12. The system of claim 9, wherein the first device is an air chuck and wherein the second device is an air chuck.

13. The apparatus of claim 12, wherein the first air chuck includes a locking clip and wherein the second air chuck includes an air-flow adjustment knob.

14. The system of claim 9, wherein the second device is an inflation needle, an inflation valve, an air nozzle tip, or an air gun tip.

15. The system of claim 9, wherein the first vessel is a tire and wherein the second vessel is a tire.

16. The system of claim 9, wherein the first vessel is a tire and wherein the second vessel is an inflatable sporting item, an inflatable floating item, or an inflatable toy.

17. A system for transferring air from one tire to another tire, comprising:
(a) a first tire containing air or other gas, wherein the air or other gas is at a predetermined pressure within the first tire;
(b) a second tire containing air or other gas, wherein the air or other gas is at a predetermined pressure within the second tire;
(c) a hose of predetermined diameter and length having a first end and a second end;
(d) a first air chuck attached to the first end of the hose for removing the air or other gas from the first tire; and
(e) a second air chuck attached to the second end of the hose for dispensing the air or other gas from the first tire into the second tire,
(f) wherein the air or other gas flows through the hose from the first air chuck to the second air chuck when the air pressure in the first tire is greater than the air pressure in the second tire.

18. The system of claim 17, further comprising at least one pressure gauge mounted on the hose at a predetermined location.

19. The system of claim 17, wherein the hose is coiled or uncoiled, wherein the length of the hose is about twelve feet to about twenty-five feet, and wherein the diameter of the hose is about one quarter inch to about three-eighths inch.

20. The system of claim 17, wherein the first air chuck includes a locking clip and wherein the second air chuck includes an air-flow adjustment knob.
